(19) United States
(12) Patent Application Publication
(10) Pub. No.: US 2016/0177173 A1
(43) Pub. Date: Jun. 23, 2016

(54) METHOD OF TREATING A HYDROCARBON CONTAINING FORMATION

(71) Applicant: SHELL OIL COMPANY, Houston, TX (US)

(72) Inventors: Paulus Johannes KUNKELER, Rotterdam (NL); Sipke Hidde WADMAN, Amsterdam (NL); Michael Joseph DOLL, Katy, TX (US); Julian Richard BARNES, Amsterdam (NL); Lori Ann PRETZER, Houston, TX (US)

(21) Appl. No.: 15/058,748

(22) Filed: Mar. 2, 2016

(30) Foreign Application Priority Data
Dec. 4, 2015 (EP) 15198086.9

(51) Int. Cl. C09K 8/584

(52) U.S. Cl. CPC C09K 8/584

(57) ABSTRACT

The invention relates to a method of treating a hydrocarbon containing formation, comprising: a) providing an aqueous composition which comprises i) a surfactant of the formula R—O—[R′—O]ₓ—X wherein R is a hydrocarbyl group, R′—O is an alkylene oxide group, x is the number of alkylene oxide groups R′—O, x is 0 or greater than 0, and X is a sulfate moiety; ii) an acid which has a pKₐ between 6 and 12; and iii) the conjugate base of the acid mentioned under ii), to at least a portion of the hydrocarbon containing formation, by combining the aqueous composition with a hydrocarbon removal fluid to produce an injectable fluid, wherein the hydrocarbon removal fluid comprises 1) water and 2) divalent cations in a concentration of 100 or more parts per million by weight (ppmw), and injecting the injectable fluid into the hydrocarbon containing formation; and b) allowing the surfactant from the injectable fluid to interact with the hydrocarbons in the hydrocarbon containing formation.

### FIELD OF THE INVENTION

The present invention relates to a method of treating a hydrocarbon containing formation using a composition which comprises a sulfate moiety containing alkoxylated or non-alkoxylated alcohol anionic surfactant.

### BACKGROUND OF THE INVENTION

Hydrocarbons, such as oil, may be recovered from hydrocarbon containing formations (or reservoirs) by penetrating the formation with one or more wells, which may allow the hydrocarbons to flow to the surface. A hydrocarbon containing formation may have one or more natural components that may aid in mobilising hydrocarbons to the surface of the wells. For example, gas may be present in the formation at sufficient levels to exert pressure on the hydrocarbons to mobilise them to the surface of the production wells. These are examples of so-called “primary oil recovery”.

However, reservoir conditions (for example permeability, hydrocarbon concentration, porosity, temperature, pressure, composition of the rock, concentration of divalent cations (or hardness), etc.) can significantly impact the economic viability of hydrocarbon production from any particular hydrocarbon containing formation. Furthermore, the above-mentioned natural pressure-providing components may become depleted over time, often long before the majority of hydrocarbons have been extracted from the reservoir. Therefore, supplemental recovery processes may be required and used to continue the recovery of hydrocarbons, such as oil, from the hydrocarbon containing formation. Such supplemental oil recovery is often called “secondary oil recovery” or “tertiary oil recovery”. Examples of known supplemental processes include waterflooding, polymer flooding, gas flooding, alkali flooding, thermal processes, solution flooding, solvent flooding, or combinations thereof.

Methods of chemical Enhanced Oil Recovery (cEOR) are applied in order to maximise the yield of hydrocarbons from a subterranean reservoir. In surfactant cEOR, the mobilisation of residual oil is achieved through surfactants which generate a sufficiently low crude oil/water interfacial tension (IFT) to give a capillary number large enough to overcome capillary forces and allow the oil to flow (Lake, Larry W., “Enhanced oil recovery”, PRENTICE HALL, Upper Saddle River, N.J., 1989, ISBN 0-13-281601-6).

It is known to use alkoxylated or non-alkoxylated alcohol sulfates as anionic surfactant in cEOR, which are hereinafter also generally referred to as alcohol sulfate surfactants. See for example WO201330140. Normally, surfactants for enhanced hydrocarbon recovery are transported to a hydrocarbon recovery location and stored at that location in the form of an aqueous solution containing for example 30 to 35 wt. % of the surfactant(s). At the hydrocarbon recovery location, such solution may be further diluted to for example a 0.05-2 wt. % solution, before it is injected into a hydrocarbon containing formation. By such dilution, an aqueous fluid is formed which fluid can be injected into the hydrocarbon containing formation.

W. Herman de Groot describes in “Sulphonation Technology in the Detergent Industry” (Kluwer Academic Publishers, 1991, pages 194-197) that during transport and storage, solutions of alcohol sulfates often are prone to hydrolysis. Such hydrolysis results in alcohol and bisulfate, thus resulting in degradation or decomposition of the alcohol sulfate product. The rate of such hydrolysis depends on conditions like pH and temperature.

That is to say, a relatively low pH and a relatively high temperature favour hydrolysis of alcohol sulfates (alkoxylated and non-alkoxylated). The above-mentioned reference by De Groot teaches that as an aid to reaching a relatively high pH (between 8 and 10), it is normal practice to buffer an alcohol sulfate product, for example with a bicarbonate/carbonate mixture. The pH of said buffering system (bicarbonate/carbonate mixture) can be calculated as follows:

HCO₃⁻+H₂O [symbol] CO₃^{2 -}+H₃O⁺

Kₐ=[CO₃²⁻][H₃O⁺]/[HCO₃^{-]}

[H₃O^{|}]=Kₐx[HCO₃]/[CO₃²]

Kₐ is the dissociation constant of the HCO₃⁻ acid with a value of 5×10⁻¹¹ (pKₐ=−log₁₀Kₐ=10.25). Thus, with equal amounts of HCO₃⁻ and CO₃²⁻ in the buffering solution, the pH will be equal to pKₐ (10.25).

As mentioned above, before an aqueous, surfactant containing solution, is injected into a hydrocarbon containing formation it may be further diluted, generally at the location of the hydrocarbon containing formation. The water or brine used in such further dilution may originate from the (location of the) hydrocarbon containing formation (from which hydrocarbons are to be recovered) or from any other source. In a case where the hydrocarbon containing formation is located in the bottom of a sea, it would be convenient to be able to use sea water as such fluid for diluting the surfactant containing solution. Sea water, however, contains a relatively high concentration of divalent cations, such as Ca²⁺ and Mg²⁺ cations. Generally, said divalent cations may be present in water or brine originating from the hydrocarbon containing formation and/or generally in water or brine (from whatever source) which is used to inject the surfactant into the hydrocarbon containing formation. For example, sea water may contain 1,700 parts per million by weight (ppmw) of divalent cations and may have a salinity of 3.6 wt. %.

Thus, in addition to being stable in the long term (no hydrolysis during a long storage time period), a surfactant containing composition, in particular an alcohol sulfate containing composition, may also have to withstand a relatively high concentration of divalent cations, as mentioned above, for example 100 ppmw or more.

In general, and also at such a high concentration of divalent cations, the surfactant should have an adequate aqueous solubility since the latter improves the injectability of the fluid comprising the surfactant composition to be injected into the hydrocarbon containing formation. Further, an adequate aqueous solubility reduces loss of surfactant through adsorption to rock within the hydrocarbon containing formation.

A problem associated with the above-mentioned high concentration of divalent cations, in a case where the pH, for example the pH of an injectable fluid obtained by diluting a surfactant containing solution with sea water, is relatively high (for example higher than 8.0), is that salts containing such divalent cation (for example magnesium cation, Mg²⁺) and an anion which does not originate from the surfactant (for example hydroxide anion, OH⁻), precipitate out (for example as solid Mg(OH)₂). The formation of such precipitates is disadvantageous in that surfactant may be lost together with such precipitate, and may therefore not be available for interaction with the crude oil. In addition, such precipitate may plug a reservoir and a hazy injection solution may give increased surfactant loss related to adsorption as the solution propagates through the reservoir. Therefore, in order to prevent such precipitates from being formed, the pH should not be too high.

In the present invention, it is an object to provide a method of treating a hydrocarbon containing formation using a composition which comprises an alcohol sulfate surfactant, wherein such measures are taken to prevent or minimize the above-discussed hydrolysis of the alcohol sulfate and at the same time, at a high divalent cation concentration, to prevent or minimize the above-discussed precipitation of salts containing a divalent cation and an anion which does not originate from the surfactant, before, during and after injection into the hydrocarbon containing formation, of an injectable fluid comprising said alcohol sulfate surfactant containing composition.

### SUMMARY OF THE INVENTION

Surprisingly, it was found that the above-mentioned object can be achieved by providing an aqueous composition which comprises i) an alcohol sulfate surfactant; ii) an acid which has a pKₐ between 6 and 12; and iii) the conjugate base of said acid, to the hydrocarbon containing formation.

Accordingly, the present invention relates to a method of treating a hydrocarbon containing formation, comprising:

a) providing an aqueous composition which comprises i) a surfactant of the formula R—O—[R′—O]ₓ—X wherein R is a hydrocarbyl group, R′—O is an alkylene oxide group, x is the number of alkylene oxide groups R′—O, x is 0 or greater than 0, and X is a sulfate moiety; ii) an acid which has a pKₐ between 6 and 12; and iii) the conjugate base of the acid mentioned under ii), to at least a portion of the hydrocarbon containing formation, by combining the aqueous composition with a hydrocarbon removal fluid to produce an injectable fluid, wherein the hydrocarbon removal fluid comprises 1) water and 2) divalent cations in a concentration of 100 or more parts per million by weight (ppmw), and injecting the injectable fluid into the hydrocarbon containing formation; and

b) allowing the surfactant from the injectable fluid to interact with the hydrocarbons in the hydrocarbon containing formation.

### BRIEF DESCRIPTION OF THE DRAWINGS

FIG. 1 relates to an embodiment for application in cEOR.

FIG. 2 relates to another embodiment for application in cEOR.

### DETAILED DESCRIPTION OF THE INVENTION

In the context of the present invention, in a case where a composition (including an injectable fluid) comprises two or more components, these components are to be selected in an overall amount not to exceed 100%.

While the method of the present invention and the composition or injectable fluid used in said method are described in terms of “comprising”, “containing” or “including” one or more various described steps and components, respectively, they can also “consist essentially of” or “consist of” said one or more various described steps and components, respectively.”.

Within the present specification, “substantially no” means that no detectible amount is present.

In the cEOR method of the present invention, the aqueous composition to be provided to the hydrocarbon containing formation comprises i) an alcohol sulfate surfactant; ii) an acid which has a pKₐ between 6 and 12; and iii) the conjugate base of said acid.

The above-mentioned “acid which has a pKₐ between 6 and 12” may take part in the following equilibrium reaction:

HA+H₂O [symbol] A⁺+H₃O⁺

wherein:

HA is the acid which has a pKₐ between 6 and 12;

A⁻ is the conjugate base of said acid;

Kₐ=[A⁻][H₃O⁺]/[HA], wherein [A⁻] means the molar concentration (in mol/l) of A⁻, and so on; and

pKₐ=−log₁₀Kₐ.

The acid denoted as “HA”, as illustrated above, is neutral. However, as further illustrated below, in the present invention the acid having a pKₐ between 6 and 12 may also be positively charged (for example: NH₄⁺ in ammonium chloride) or negatively charged (for example: the dicarboxylate derivative of citric acid which is 2-hydroxypropane-1,2,3-tricarboxylic acid). For example, in the case of a positively charged acid, the above-mentioned equilibrium reaction may be:

HA⁺+H₂O [symbol] A+H₃O⁺

In the present invention, surprisingly and advantageously, by requiring the alcohol sulfate surfactant in the aqueous composition to be combined with an acid which has a pKₐ between 6 and 12 and with the conjugate base of such acid, hydrolysis of the alcohol sulfate is prevented or minimized (e.g. delayed in time), and at the same time, at a high divalent cation concentration, the precipitation of salts containing a divalent cation and an anion which does not originate from the surfactant, before, during and after injection into the hydrocarbon containing formation, of an injectable fluid comprising the alcohol sulfate surfactant containing composition, is prevented or minimized (e.g. delayed in time).

Further, it has appeared that with the present invention there is no or little risk of so-called “undershooting” to a low pH, not even locally. Typically, upon sulfation and neutralization, the pH of the resulting aqueous alcohol sulfate containing solution is of from 11 to 14 (as further described below). By only adding an acid having a pKₐ of 6 or lower, such as hydrochloric acid (HCl), to such solution, one runs the risk of “undershooting” and ending up with a pH which is too low (for example below 7) and which may initiate hydrolysis (degradation) of the alcohol sulfate. Such “undershooting” is caused by the acid-base titration curve for these acids (having a pKₐ of 6 or lower) neutralizing the base (for example NaOH) as contained in the aqueous alcohol sulfate containing solution having a high pH. According to such acid-base titration curve, the pH drops significantly over a very small concentration range of the added acid. For example, in a case where HCl is added to neutralize NaOH, the pH may drop from about 11 to about 3 within only a very small concentration range for HCl.

Still further, insufficient mixing of the acid with the aqueous alcohol sulfate containing solution having a high pH may result in local “hot spots” where the acid concentration is relatively high. In a case where in such “hot spots”, an acid having a relatively low pKₐ (6 or lower) is present, acid catalyzed hydrolysis of the alcohol sulfate in those spots may easily be initiated. Moreover, once initiated, such hydrolysis results in alcohol and bisulfate, which bisulfate is also an acid (pKₐ=2.0), thereby resulting in further autocatalytic acidic hydrolysis.

In the present invention, the above issues are advantageously avoided or minimized by using an acid, which has a pKₐ between 6 and 12, and its conjugate base. For, in a case where only an acid having a pKₐ of 6 or lower is used, one would have to apply the following risky and time-consuming procedure: a) slow, stepwise titration (addition) of the acid to neutralise the base in the alcohol sulfate containing solution; b) efficient mixing for full homogeneity at each step to avoid acid “hot spots” which would result in alcohol sulfate decomposition, and c) checking the pH of the resulting mixture at each stage (step) to ensure that the pH of the solution would not become too low (for example drop below pH=7).

Still further, the high pH solution obtained after sulfation and neutralization is a more difficult product to handle in transport and use at facilities due to its high pH, involving for example human safety issues and material corrosion disadvantages, as compared to the lower pH buffered aqueous solution used in the present invention.

The acid to be used in the present invention has a pKₐ between 6 and 12. In the present invention, said pKₐ is the pKₐ as measured at a temperature of 20° C. and under atmospheric pressure. Suitably, the pKₐ of the acid to be used in the present invention is at least higher than 6, or may be at least 7, and is at most lower than 12, or may be at most 11, or at most 10, or at most 9. Thus, the pKₐ of said acid is of from higher than 6 to lower than 12, and may be of from 6 to 11, or of from 6 to 10, or of from 6 to 9. Generally, it is preferred that the pKₐ of the acid having a pKₐ between 6 and 12 is lower than the pH of the aqueous alcohol sulfate surfactant containing composition to which said acid may be added.

In the present invention, any acid having a pKₐ between 6 and 12 may be used. The acid may be organic or inorganic. For example, suitable acids having a pKₐ between 6 and 12 are listed at pages D-161 to D-165 in the following publication: “CRC Handbook of Chemistry and Physics”, 1989-1990, 70^{th} edition, CRC Press, Inc.

Organic acids having a pKₐ between 6 and 12 which can suitably be used in the present invention comprise any amine-acid complexes having a pKₐ between 6 and 12, for example an amine-acid complex of the formula (NR₃)_{y}.acid having a pKₐ between 6 and 12, wherein:

none, one, two or all of the three R moieties is or are hydrogen and none, one, two or all of the three R moieties is or are an alkyl group, which alkyl group may contain 1 to 20 carbon atoms, suitably 1 to 10 carbon atoms, and which alkyl group may be unsubstituted or substituted, in particular substituted by one or more heteroatom containing groups such as a hydroxyl group (—OH), a keto group (═O), an amine group (—NH₂), a carboxylic acid group (—C(O)OH) or a carboxylate group (—C(O)O);

y is equal to the number of acidic protons in the acid; and

the acid may be an acid having a pKₐ of 6 or lower, for example hydrocloric acid (HCl) and sulfuric acid (H₂SO₄).

Suitable examples of the above-mentioned amine-acid complex of the formula (NR₃)_{y}.acid include:

1) ammonium chloride: NH₃.HCl (or NH₄Cl)

2) ammonium sulfate: (NH₃)₂.H₂SO₄ (or (NH₄)₂SO₄)

3) complex of ethanolamine and HCl: HOCH₂CH₂NH₂.HCl

4) complex of diethanolamine and HCl: (HOCH₂CH₂)₂NH.HCl

5) complex of triethanolamine and HCl: (HOCH₂CH₂)₃N.HCl

In a case where an amine group containing compound as described above has 2 or more amine groups (polyamine) instead of just 1 amine group, multiple complexes of the above-described acid with the 2 or more amine groups in the same polyamine molecule may be formed. These 2 or more amine groups may be primary and/or secondary amine groups. In a case where the resulting complex has a pKₐ between 6 and 12, it may also suitably be used in the present invention. A suitable example is the complex of hydrogen chloride with ethylene diamine, which can be represented as HCl.NH₂CH₂CH₂NH₂.HCl (ethylene diamine.2HCl). Other suitable examples are the complexes of hydrogen chloride with triethylene tetramine (NH₂CH₂CH₂NHCH₂CH₂NHCH₂CH₂NH₂) or tetraethylene pent amine.

Another class of organic acids having a pKₐ between 6 and 12 which can suitably be used in the present invention comprises aliphatic acids which contain 1 or more carboxylic acid (—CO₂H) groups and optionally 1 or more carboxylate (—CO₂⁻) groups and which have a pKₐ between 6 and 12. Within the present specification, “aliphatic” means “non-aromatic”.

Said aliphatic acid may have 1 to 15 carbon atoms, suitably 2 to 10 carbon atoms, more suitably 2 to 8 carbon atoms, including the carbon atoms from the carboxylic acid and carboxylate groups. Further, said aliphatic acid may be substituted with one or more substituents other than a carboxylic acid or carboxylate group. Suitable other substituents are hydroxyl (—OH), keto (═O) and amine (—NH₂), preferably hydroxyl. Said aliphatic acid may comprise 1 to 3, preferably 2 to 3, more preferably 3 carboxylic acid and carboxylate groups. Still further, said aliphatic acid may contain one or more carbon-carbon double bonds, that is to say it may be saturated or unsaturated.

Suitable examples of said aliphatic acid having a pKₐ between 6 and 12 are the monocarboxylate derivative of maleic acid and the dicarboxylate derivative of citric acid. The dicarboxylate derivative of citric acid is preferred.

Further, any inorganic acids having a pKₐ between 6 and 12 can also suitably be used in the present invention, for example:

1) Bicarbonate, HCO₃⁻, as in sodium bicarbonate.

2) Boric acid, B(OH)₃.

3) Dihydrogen phosphate, H₂PO₄⁻, as in sodium dihydrogen phosphate.

Preferably, in the present invention, the aqueous solubility of the acid having a pKₐ between 6 and 12 and the aqueous solubility of its conjugate base are sufficiently high, both in the alcohol sulfate surfactant containing aqueous composition and in the injectable fluid that may be produced from such aqueous composition.

Further, preferably in the present invention, the molar ratio of the total molar amount of the acid having a pKₐ between 6 and 12 and its conjugate base to the molar amount of the alcohol sulfate surfactant is of from 0 to 5, or may be of from 0.01 to 2 or of from 0.05 to 1.5 or of from 0.1 to 1 or of from 0.15 to 0.5.

Further, the aqueous composition to be used in the cEOR method of the present invention, comprises an alcohol sulfate sufactant, more in particular a surfactant of the formula R—O—[R′—O]ₓ—X, hereinafter also referred to as formula (I), wherein R is a hydrocarbyl group, R′—O is an alkylene oxide group, x is the number of alkylene oxide groups R′—O, x is 0 or greater than 0, and X is a sulfate moiety.

In the present invention, the weight average carbon number for the hydrocarbyl group R in said formula (I) may be of from 5 to 35, preferably 10 to 30, more preferably 15 to 25.

The hydrocarbyl group R in said formula (I) may be aliphatic or aromatic, suitably aliphatic. When said hydrocarbyl group R is aliphatic, it may be an alkyl group, cycloalkyl group or alkenyl group, suitably an alkyl group. Said hydrocarbyl group may be substituted by another hydrocarbyl group as described hereinbefore or by a substituent which contains one or more heteroatoms, such as a hydroxy group or an alkoxy group.

The non-alkoxylated alcohol R—OH, from which the hydrocarbyl group R in the above formula (I) originates, may be an alcohol containing 1 hydroxyl group (mono-alcohol) or an alcohol containing of from 2 to 6 hydroxyl groups (poly-alcohol). Suitable examples of poly-alcohols are diethylene glycol, dipropylene glycol, glycerol, pentaerythritol, trimethylolpropane, sorbitol and mannitol. Preferably, in the present invention, the hydrocarbyl group R in the above formula (I) originates from a non-alkoxylated alcohol R—OH which only contains 1 hydroxyl group (mono-alcohol). Further, said alcohol may be a primary or secondary alcohol, preferably a primary alcohol.

The non-alkoxylated alcohol R—OH, wherein R is an aliphatic group and from which the hydrocarbyl group R in the above formula (I) originates, may comprise a range of different molecules which may differ from one another in terms of carbon number for the aliphatic group R, the aliphatic group R being branched or unbranched, number of branches for the aliphatic group R, and molecular weight.

Preferably, the hydrocarbyl group R in the above formula (I) is an alkyl group. Said alkyl group may be linear or branched, and may have a weight average carbon number of from of from 5 to 35, preferably 10 to 30, more preferably 15 to 25. In a case where said alkyl group is linear and contains 3 or more carbon atoms, the alkyl group is attached either via its terminal carbon atom or an internal carbon atom to the oxygen atom, preferably via its terminal carbon atom.

The non-alkoxylated alcohol R—OH, from which the hydrocarbyl group R in the above formula (I) originates, may be prepared in any way. For example, a primary aliphatic alcohol may be prepared by hydroformylation of a branched olefin. Preparations of branched olefins are described in U.S. Pat. No. 5,510,306, U.S. Pat. No. 5,648,584 and U.S. Pat. No. 5,648,585. Preparations of branched long chain aliphatic alcohols are described in U.S. Pat. No. 5,849,960, U.S. Pat. No. 6,150,222, U.S. Pat. No. 6,222,077.

Suitable examples of commercially available non-alkoxylated alcohols (of said formula R—OH) are the NEODOL alcohols (NEODOL, as used throughout this text, is a trademark), sold by Shell Chemical Company. For example, said NEODOL alcohols include NEODOL 91 which is a mixture of mainly C₉, C₁₀ and C₁₁ alcohols of which the weight average carbon number is 10.2; NEODOL 25 which is a mixture of mainly C₁₂, C₁₃, C₁₄ and C₁₅ alcohols of which the weight average carbon number is 13.5; NEODOL 45 which is a mixture of mainly C₁₄ and C₁₅ alcohols of which the weight average carbon number is 14.5; and NEODOL 67 which is a mixture of mainly C₁₆ and C₁₇ alcohols of which the weight average carbon number is 16.7.

The alkylene oxide groups R′—O in the above formula (I) may comprise any alkylene oxide groups. For example, said alkylene oxide groups may comprise ethylene oxide groups, propylene oxide groups and butylene oxide groups or a mixture thereof, such as a mixture of ethylene oxide and propylene oxide groups. Preferably, said alkylene oxide groups consist of ethylene oxide groups or propylene oxide groups or a mixture of ethylene oxide and propylene oxide groups. In case of a mixture of different alkylene oxide groups, the mixture may be random or blockwise. In case said alkylene oxide groups consist of a mixture of ethylene oxide and propylene oxide groups, the mixture is preferably blockwise, more preferably first a propylene oxide block followed by an ethylene oxide block (or ethylene oxide cap).

In the above formula (I), x represents the number of alkylene oxide groups R′—O. In the present invention, either x is 0 (non-alkoxylated alcohol) or greater than 0 (alkoxylated alcohol). In a case where x is greater than 0, the average value for x may be at least 0.5, suitably of from 1 to 50, more suitably of from 1 to 40, more suitably of from 2 to 35, more suitably of from 2 to 30, more suitably of from 2 to 25, more suitably of from 3 to 20, more suitably of from 3 to 18, more suitably of from 4 to 16, most suitably of from 5 to 12.

The above-mentioned (non-alkoxylated) alcohol R—OH, from which the hydrocarbyl group R in the above formula (I) originates, may be alkoxylated by reacting with alkylene oxide in the presence of an appropriate alkoxylation catalyst. The alkoxylation catalyst may be potassium hydroxide or sodium hydroxide which is commonly used commercially. Alternatively, a double metal cyanide catalyst may be used, as described in U.S. Pat. No. 6,977,236. Still further, a lanthanum-based or a rare earth metal-based alkoxylation catalyst may be used, as described in U.S. Pat. No. 5,059,719 and U.S. Pat. No. 5,057,627. The alkoxylation reaction temperature may range from 90° C. to 250° C., suitably 120 to 220° C., and super atmospheric pressures may be used if it is desired to maintain the alcohol substantially in the liquid state.

Preferably, the alkoxylation catalyst is a basic catalyst, such as a metal hydroxide, wick catalyst contains a Group IA or Group IIA metal ion. Suitably, when the metal ion is a Group IA metal ion, it is a lithium, sodium, potassium or cesium ion, more suitably a sodium or potassium ion, most suitably a potassium ion. Suitably, when the metal ion is a Group IIA metal ion, it is a magnesium, calcium or barium ion. Thus, suitable examples of the alkoxylation catalyst are lithium hydroxide, sodium hydroxide, potassium hydroxide, cesium hydroxide, magnesium hydroxide, calcium hydroxide and barium hydroxide, more suitably sodium hydroxide and potassium hydroxide, most suitably potassium hydroxide. Usually, the amount of such alkoxylation catalyst is of from 0.01 to 5 wt. %, more suitably 0.05 to 1 wt. %, most suitably 0.1 to 0.5 wt.%, based on the total weight of the catalyst, alcohol and alkylene oxide (i.e. the total weight of the final reaction mixture).

The alkoxylation procedure serves to introduce a desired average number of alkylene oxide units per mole of alcohol alkoxylate (that is alkoxylated alcohol), wherein different numbers of alkylene oxide units are distributed over the alcohol alkoxylate molecules. For example, treatment of an alcohol with 7 moles of alkylene oxide per mole of primary alcohol serves to effect the alkoxylation of each alcohol molecule with 7 alkylene oxide groups, although a substantial proportion of the alcohol will have become combined with more than 7 alkylene oxide groups and an approximately equal proportion will have become combined with less than 7. In a typical alkoxylation product mixture, there may also be a minor proportion of unreacted alcohol.

Further, in the present invention, X in the above formula (I) is a sulfate moiety, which is an anionic moiety. That is to say, the compound of the above formula (I) is an anionic surfactant. Thus, in the present invention, the surfactant is of the formula R—O—[R′—O]ₓ—SO₃, wherein R, R′ and x have the above-described meanings, and wherein the —O—SO₃⁻ moiety is the sulfate moiety.

Further, in the present invention, the cation for the anionic surfactant may be any cation, such as an ammonium, alkali metal or alkaline earth metal cation, preferably an ammonium or alkali metal cation. Surfactants of the formula (I) wherein X is a sulfate moiety may be prepared from the above-described non-alkoxylated or alkoxylated alcohols of the formula R—O—[R′—O]ₓ—H, as is further described hereinbelow.

The non-alkoxylated or alkoxylated alcohol R—O—[R′—O]ₓ—H may be sulfated by any one of a number of well-known methods, for example by using one of a number of sulfating agents including sulfur trioxide, complexes of sulfur trioxide with (Lewis) bases, such as the sulfur trioxide pyridine complex and the sulfur trioxide trimethylamine complex, chlorosulfonic acid and sulfamic acid. The sulfation may be carried out at a temperature preferably not above 80° C. The sulfation may be carried out at temperature as low as −20° C. For example, the sulfation may be carried out at a temperature from 20 to 70° C., preferably from 20 to 60° C., and more preferably from 20 to 50° C.

Said alcohol may be reacted with a gas mixture which in addition to at least one inert gas contains from 1 to 8 vol. %, relative to the gas mixture, of gaseous sulfur trioxide, preferably from 1.5 to 5 vol. %. Although other inert gases are also suitable, air or nitrogen are preferred.

The reaction of said alcohol with the sulfur trioxide containing inert gas may be carried out in falling film reactors. Such reactors utilize a liquid film trickling in a thin layer on a cooled wall which is brought into contact in a continuous current with the gas. Kettle cascades, for example, would be suitable as possible reactors. Other reactors include stirred tank reactors, which may be employed if the sulfation is carried out using sulfamic acid or a complex of sulfur trioxide and a (Lewis) base, such as the sulfur trioxide pyridine complex or the sulfur trioxide trimethylamine complex.

Following sulfation, the liquid reaction mixture may be neutralized using an aqueous alkali metal hydroxide, such as sodium hydroxide or potassium hydroxide, an aqueous alkaline earth metal hydroxide, such as magnesium hydroxide or calcium hydroxide, or bases such as ammonium hydroxide, substituted ammonium hydroxide, sodium carbonate or potassium hydrogen carbonate. The neutralization procedure may be carried out over a wide range of temperatures and pressures. For example, the neutralization procedure may be carried out at a temperature from 0° C. to 65° C. and a pressure in the range from 100 to 200 kPa abs.

Preferably, the above-mentioned acid having a pKₐ between 6 and 12 is added to the alcohol sulfate surfactant containing solution after the above-mentioned neutralization. Before said acid is added and afer said neutralization, the aqueous alcohol sulfate surfactant containing solution normally comprises 0.1 to 1 wt. % of an aqueous alkali metal hydroxide, such as sodium hydroxide, suitably 0.2 to 0.6 wt. %, more suitably 0.2 to 0.5 wt. %, and normally has a pH of from 11 to 14, suitably 11 to 12. By adding said acid, the pH of said solution may be reduced, suitably to a pH of from 7 to 11, or 8 to 11, or 8 to 10, or 9 to 10.

In the present invention, it is also envisaged that first an acid having a pKₐ of 6 or lower (for example acetic acid which has a pKₐ of 4.8), preferably a relatively small amount of such acid, is added to the aqueous alcohol sulfate surfactant containing solution, during and after which addition said solution is preferably mixed thoroughly. After such acid having a relatively low pKₐ has been added, the above-mentioned acid having a pKₐ between 6 and 12 (for example the dicarboxylate derivative of citric acid which has a pKₐ of 6.4) is added in accordance with the present invention.

Still further, it is envisaged in the present invention that instead of adding different acids (more than once) as described above, only once an acid is added, namely an acid which has a pKₐ of 6 or lower but which acid also has a deprotonated derivative having a pKₐ between 6 and 12. In this case, a relatively small amount of such acid having a pKₐ of 6 or lower may be added. Further, during and after said addition, the solution is preferably mixed thoroughly. For example, the monocarboxylate derivative of citric acid (pKₐ=4.8) may be added which may be converted into the dicarboxylate derivative of citric acid (pKₐ=6.4) which in turn may be further converted into its conjugate base (tricarboxylate derivative of citric acid). Further, for example, phosphoric acid (pKₐ=2.1) may be added which may be converted into dihydrogen phosphate (pKₐ=7.2) which in turn may be further converted into its conjugate base (monohydrogen phosphate).

In the present invention, a co-solvent (or solubilizer) may be added to increase the solubility of the surfactant(s) in the aqueous composition and/or in the below-mentioned injectable fluid comprising said composition used in the present cEOR method. Any amount of co-solvent needed to dissolve all of the surfactant at a certain salt concentration (salinity) may be easily determined by a skilled person through routine tests. Suitable co-solvents include low molecular weight alcohols and other organic solvents or combinations thereof.

Suitable low molecular weight alcohols for use as co-solvent include C₁-C₁₀ alkyl alcohols, more suitably C₁-C₈ alkyl alcohols, most suitably C₁-C₆ alkyl alcohols, or combinations thereof. Examples of suitable C₁-C₄ alkyl alcohols are methanol, ethanol, 1-propanol, 2-propanol (isopropyl alcohol), 1-butanol, 2-butanol (sec-butyl alcohol), 2-methyl-1-propanol (iso-butyl alcohol) and 2-methyl-2-propanol (tert-butyl alcohol). Examples of suitable C₅ alkyl alcohols are 1-pentanol, 2-pentanol and 3-pentanol, and branched C₅ alkyl alcohols, such as 2-methyl-2-butanol (tert-amyl alcohol). Examples of suitable C₆ alkyl alcohols are 1-hexanol, 2-hexanol and 3-hexanol, and branched C₆ alkyl alcohols

Suitable other organic solvents for use as co-solvent include methyl ethyl ketone, acetone, lower alkyl cellosolves, lower alkyl carbitols or combinations thereof.

Further, one or more compounds which under the conditions in a hydrocarbon containing formation may be converted into any of the above-mentioned co-colvents may be used, such as one or more of the above-mentioned low molecular weight alcohols. Such precursor co-solvent compounds may include ether compounds, such as ethylene glycol monobutyl ether (ELBE), diethylene glycol monobutyl ether (DCBE) and triethylene glycol monobutyl ether (TGBE). The latter 3 ether compounds may be converted under the conditions in a hydrocarbon containing formation into ethanol and 1-butanol.

Still further, polyethylene glycol and/or an alcohol ethoxylate may be used as co-solvent.

Thus, the present invention relates to a method of treating a hydrocarbon containing formation, comprising:

a) providing the above-described aqueous composition which comprises i) an alcohol sulfate surfactant; ii) an acid which has a pKₐ between 6 and 12; and iii) the conjugate base of said acid, to at least a portion of the hydrocarbon containing formation, by combining the aqueous composition with a hydrocarbon removal fluid to produce an injectable fluid, wherein the hydrocarbon removal fluid comprises 1) water and 2) divalent cations in a concentration of 100 or more parts per million by weight (ppmw), and injecting the injectable fluid into the hydrocarbon containing formation; and

b) allowing the surfactant from the injectable fluid to interact with the hydrocarbons in the hydrocarbon containing formation.

In the present invention, the above-described aqueous composition is combined with a hydrocarbon removal fluid to produce an injectable fluid, suitably at the location of the hydrocarbon containing formation, after which the injectable fluid is injected into the hydrocarbon containing formation. Said hydrocarbon removal fluid comprises 1) water and 2) divalent cations in a concentration of 100 or more parts per million by weight (ppmw). It may also comprise monovalent cations. By said concentration of divalent cations reference is made to the concentration of divalent cations in the water (e.g. brine) in combination with which the above-described aqueous composition which comprises i) an alcohol sulfate surfactant and ii) an acid which has a pKₐ between 6 and 12, is provided to at least a portion of the hydrocarbon containing formation. Said water may originate from the hydrocarbon containing formation or from any other source, such as river water, sea water or aquifer water. A suitable example is sea water which may contain 1,700 ppmw of divalent cations. Suitably, said divalent cations comprise calcium (Ca²⁺) and magnesium (Me) cations. Further, preferably, said concentration of divalent cations is of from 100 to 25,000 ppmw. In practice, said concentration of divalent cations may vary strongly between different sources. In the present invention, said concentration of divalent cations is at least 100 ppmw, suitably at least 200 ppmw, more suitably at least 500 ppmw, more suitably at least 1,000 ppmw, more suitably at least 1,500 ppmw, more suitably at least 2,000 ppmw, most suitably at least 3,000 ppmw. Further, said concentration of divalent cations may be at most 25,000 ppmw, suitably at most 20,000 ppmw, more suitably at most 15,000 ppmw, more suitably at most 10,000 ppmw, suitably at most 8,000 ppmw, more suitably at most 6,000 ppmw, most suitably at most 5,000 ppmw.

Further, in the present invention, the salinity of said water (e.g. brine), which may originate from the hydrocarbon containing formation or from any other source, may be of from 0.5 to 30 wt. % or 0.5 to 20 wt. % or 0.5 to 10 wt. % or 1 to 6 wt. %. By said “salinity” reference is made to the concentration of total dissolved solids (% TDS), wherein the dissolved solids comprise dissolved salts. Said salts may be salts comprising divalent cations, such as magnesium chloride and calcium chloride, and salts comprising monovalent cations, such as sodium chloride and potassium chloride. Sea water may have a salinity (% TDS) of 3.6 wt. %.

Sea water may also contain a certain amount of an acid having a pKₐ between 6 and 12 and/or its conjugate base, for example bicarbonate/carbonate. In case such sea water is used to dilute the alcohol sulfate surfactant containing aqueous composition thereby producing an injectable fluid, it is preferred that before forming such injectable fluid, the amount and/or type of the acid having a pKₐ between 6 and 12 and its conjugate base in said aqueous composition is/are such that in the injectable fluid the target pH may be achieved, thus taking into account the composition of the sea water.

In the method of the present invention, the temperature may be 25° C. or higher. By said temperature reference is made to the temperature in the hydrocarbon containing formation. Preferably, said temperature is of from 25 to 200° C., more preferably of from 25 to 150° C., most preferably of from 25 to 80° C. In practice, said temperature may vary strongly between different hydrocarbon containing formations.

In the present method of treating a hydrocarbon containing formation, in particular a crude oil-bearing formation, the surfactant which is a non-alkoxylated or alkoxylated alcohol sulfate surfactant is applied in cEOR (chemical Enhanced Oil Recovery) at the location of the hydrocarbon containing formation, more in particular by providing the above-described composition, via the above-mentioned injectable fluid, to at least a portion of the hydrocarbon containing formation and then allowing the surfactant from said composition to interact with the hydrocarbons in the hydrocarbon containing formation.

Normally, as also discussed in the introduction above, surfactants for enhanced hydrocarbon recovery are transported to a hydrocarbon recovery location and stored at that location in the form of an aqueous solution containing for example 30 to 35 wt. % of the surfactant(s). At the hydrocarbon recovery location, such solution would then be further diluted to a 0.05-2 wt. % solution, before it is injected into a hydrocarbon containing formation. By such dilution, an aqueous fluid is formed which fluid can be injected into the hydrocarbon containing formation, that is to say an injectable fluid. The water or brine used in such further dilution may originate from the hydrocarbon containing formation (from which hydrocarbons are to be recovered) or from any other source.

The total amount of the surfactant(s) in said injectable fluid may be of from 0.05 to 2 wt. %, preferably 0.1 to 1.5 wt. %, more preferably 0.1 to 1.0 wt. %, most preferably 0.2 to 0.7 wt. %.

In the present invention, the above-mentioned injectable fluid may also comprise a polymer as further described below. The polymer may be added to the injectable fluid, or to the surfactant containing aqueous composition before forming the injectable fluid. The main function of the polymer is to increase viscosity. In particular, the polymer may provide mobility control (relative to the oil phase) as the injectable fluid propagates from the injection well to the production well, and stimulate the formation of an oil bank that is pushed to such production well.

Thus, the polymer should be a viscosity increasing polymer. More in particular, in the present invention, the polymer should increase the viscosity of an aqueous fluid in which the aqueous surfactant containing composition has been dissolved, which aqueous fluid may then be injected into a hydrocarbon containing formation. For production from a hydrocarbon containing formation may be enhanced by treating the hydrocarbon containing formation with a polymer that may mobilise hydrocarbons to one or more production wells. The polymer may reduce the mobility of the water phase, because of the increased viscosity, in pores of the hydrocarbon containing formation. The reduction of water mobility may allow the hydrocarbons to be more easily mobilised through the hydrocarbon containing formation.

Suitable polymers performing the above-mentioned function of increasing viscosity in enhanced oil recovery, for use in the present invention, and preparations thereof, are described in U.S. Pat. No. 6,427,268, U.S. Pat. No. 6,439,308, U.S. Pat. No. 5,654,261, U.S. Pat. No. 5,284,206, U.S. Pat. No. 5,199,490 and U.S. Pat. No. 5,103,909, and also in “Viscosity Study of Salt Tolerant Polymers”, Rashidi et al., Journal of Applied Polymer Science, volume 117, pages 1551-1557, 2010.

Suitable commercially available polymers for cEOR include Flopaam® manufactured by SNF Floerger, CIBA® ALCOFLOOD® manufactured by Ciba Specialty Additives (Tarrytown, N.Y.), Tramfloc® manufactured by Tramfloc Inc. (Temple, Ariz.) and HE® polymers manufactured by Chevron Phillips Chemical Co. (The Woodlands, Tex.). A specific suitable polymer commercially available at SNF Floerger is Flopaam® 3630 which is a partially hydrolysed polyacrylamide.

The nature of the polymer is not relevant in the present invention, as long as the polymer can increase viscosity.

That is, the molecular weight of the polymer should be sufficiently high to increase viscosity. Suitably, the molecular weight of the polymer is at least 1 million Dalton, more suitably at least 2 million Dalton, most suitably at least 4 million Dalton. The maximum for the molecular weight of the polymer is not essential. Suitably, the molecular weight of the polymer is at most 30 million Dalton, more suitably at most 25 million Dalton.

Further, the polymer may be a homopolymer, a copolymer or a terpolymer. Still further, the polymer may be a synthetic polymer or a biopolymer or a derivative of a biopolymer. Examples of suitable biopolymers or derivatives of biopolymers include xanthan gum, guar gum and carboxymethyl cellulose.

A suitable monomer for the polymer, suitably a synthetic polymer, is an ethylenically unsaturated monomer of formula R¹R²C═CR³R⁴, wherein at least one of the R¹, R², R³ and R⁴ substituents is a substituent which contains a moiety selected from the group consisting of —C(═O)NH₂, —C(═O)OH, —C(═O)OR wherein R is a branched or linear C₆-C₁₈ alkyl group, —OH, pyrrolidone and —SO₃H (sulfonic acid), and the remaining substituent(s), if any, is (are) selected from the group consisting of hydrogen and alkyl, preferably C₁-C₄ alkyl, more preferably methyl. Most preferably, said remaining substituent(s), if any, is (are) hydrogen. Suitably, a polymer is used that is made from such ethylenically unsaturated monomer.

Suitable examples of the ethylenically unsaturated monomer as defined above, are acrylamide, acrylic acid, lauryl acrylate, vinyl alcohol, vinylpyrrolidone, and styrene sulfonic acid and 2-acrylamido-2-methylpropane sulfonic acid. Suitable examples of ethylenic homopolymers that are made from such ethylenically unsaturated monomers are polyacrylamide, polyacrylate, polylauryl acrylate, polyvinyl alcohol, polyvinylpyrrolidone, and polystyrene sulfonate and poly(2-acrylamido-2-methylpropane sulfonate). For these polymers, the counter cation for the —C(═O)O⁻ moiety (in the case of polyacrylate) and for the sulfonate moiety may be an alkali metal cation, such as a sodium ion, or an ammonium ion.

As mentioned above, copolymers or terpolymers may also be used. Examples of suitable ethylenic copolymers include copolymers of acrylic acid and acrylamide, acrylic acid and lauryl acrylate, and lauryl acrylate and acrylamide.

Preferably, the polymer which may be used in the present invention is a polyacrylamide, more preferably a partially hydrolysed polyacrylamide. A partially hydrolysed polyacrylamide contains repeating units of both-[CH₂—CHC(═O)NH₂]— and —[CH₂—CHC(═O)O⁻M⁺]— wherein M⁺ may be an alkali metal cation, such as a sodium ion, or an ammonium ion. The extent of hydrolysis is not essential and may vary within wide ranges. For example, 1 to 99 mole %, or 5 to 95 mole %, or 10 to 90 mole %, suitably 15 to 40 mole %, more suitably 20 to 35 mole %, of the polyacrylamide may be hydrolysed.

Hydrocarbons may be produced from hydrocarbon containing formations through wells penetrating such formations. “Hydrocarbons” are generally defined as molecules formed primarily of carbon and hydrogen atoms such as oil and natural gas. Hydrocarbons may also include other elements, such as halogens, metallic elements, nitrogen, oxygen and/or sulfur. Hydrocarbons derived from a hydrocarbon containing formation may include kerogen, bitumen, pyrobitumen, asphaltenes, oils or combinations thereof. Hydrocarbons may be located within or adjacent to mineral matrices within the earth. Matrices may include sedimentary rock, sands, silicilytes, carbonates, diatomites and other porous media.

A “hydrocarbon containing formation” may include one or more hydrocarbon containing layers, one or more non-hydrocarbon containing layers, an overburden and/or an underburden. An overburden and/or an underburden includes one or more different types of impermeable materials. For example, overburden/underburden may include rock, shale, mudstone, or wet/tight carbonate (that is to say an impermeable carbonate without hydrocarbons). For example, an underburden may contain shale or mudstone. In some cases, the overburden/underburden may be somewhat permeable. For example, an underburden may be composed of a permeable mineral such as sandstone or limestone.

Properties of a hydrocarbon containing formation may affect how hydrocarbons flow through an underburden/overburden to one or more production wells. Properties include porosity, permeability, pore size distribution, surface area, salinity or temperature of formation. Overburden/underburden properties in combination with hydrocarbon properties, capillary pressure (static) characteristics and relative permeability (flow) characteristics may affect mobilisation of hydrocarbons through the hydrocarbon containing formation.

Fluids (for example gas, water, hydrocarbons or combinations thereof) of different densities may exist in a hydrocarbon containing formation. A mixture of fluids in the hydrocarbon containing formation may form layers between an underburden and an overburden according to fluid density. Gas may form a top layer, hydrocarbons may form a middle layer and water may form a bottom layer in the hydrocarbon containing formation. The fluids may be present in the hydrocarbon containing formation in various amounts. Interactions between the fluids in the formation may create interfaces or boundaries between the fluids. Interfaces or boundaries between the fluids and the formation may be created through interactions between the fluids and the formation. Typically, gases do not form boundaries with other fluids in a hydrocarbon containing formation. A first boundary may form between a water layer and underburden. A second boundary may form between a water layer and a hydrocarbon layer. A third boundary may form between hydrocarbons of different densities in a hydrocarbon containing formation.

Production of fluids may perturb the interaction between fluids and between fluids and the overburden/underburden. As fluids are removed from the hydrocarbon containing formation, the different fluid layers may mix and form mixed fluid layers. The mixed fluids may have different interactions at the fluid boundaries. Depending on the interactions at the boundaries of the mixed fluids, production of hydrocarbons may become difficult.

Quantification of energy required for interactions (for example mixing) between fluids within a formation at an interface may be difficult to measure. Quantification of energy levels at an interface between fluids may be determined by generally known techniques (for example spinning drop tensiometer). Interaction energy requirements at an interface may be referred to as interfacial tension. “Interfacial tension” as used herein, refers to a surface free energy that exists between two or more fluids that exhibit a boundary. A high interfacial tension value (for example greater than 10 mN/m) may indicate the inability of one fluid to mix with a second fluid to form a fluid emulsion. As used herein, an “emulsion” refers to a dispersion of one immiscible fluid into a second fluid by addition of a compound that reduces the interfacial tension between the fluids to achieve stability. The inability of the fluids to mix may be due to high surface interaction energy between the two fluids. Low interfacial tension values (for example less than 1 mN/m) may indicate less surface interaction between the two immiscible fluids. Less surface interaction energy between two immiscible fluids may result in the mixing of the two fluids to form an emulsion. Fluids with low interfacial tension values may be mobilised to a well bore due to reduced capillary forces and subsequently produced from a hydrocarbon containing formation. Thus, in surfactant cEOR, the mobilisation of residual oil is achieved through surfactants which generate a sufficiently low crude oil/water interfacial tension (IFT) to give a capillary number large enough to overcome capillary forces and allow the oil to flow.

Mobilisation of residual hydrocarbons retained in a hydrocarbon containing formation may be difficult due to viscosity of the hydrocarbons and capillary effects of fluids in pores of the hydrocarbon containing formation. As used herein “capillary forces” refers to attractive forces between fluids and at least a portion of the hydrocarbon containing formation. Capillary forces may be overcome by increasing the pressures within a hydrocarbon containing formation. Capillary forces may also be overcome by reducing the interfacial tension between fluids in a hydrocarbon containing formation. The ability to reduce the capillary forces in a hydrocarbon containing formation may depend on a number of factors, including the temperature of the hydrocarbon containing formation, the salinity of water in the hydrocarbon containing formation, and the composition of the hydrocarbons in the hydrocarbon containing formation.

As production rates decrease, additional methods may be employed to make a hydrocarbon containing formation more economically viable. Methods may include adding sources of water (for example brine, steam), gases, polymers or any combinations thereof to the hydrocarbon containing formation to increase mobilisation of hydrocarbons.

In the present invention, the hydrocarbon containing formation is thus treated with a surfactant(s) containing injectable fluid, as described above. Interaction of said fluid with the hydrocarbons may reduce the interfacial tension of the hydrocarbons with one or more fluids in the hydrocarbon containing formation. The interfacial tension between the hydrocarbons and an overburden/underburden of a hydrocarbon containing formation may be reduced. Reduction of the interfacial tension may allow at least a portion of the hydrocarbons to mobilise through the hydrocarbon containing formation.

The ability of the surfactant(s) containing injectable fluid to reduce the interfacial tension of a mixture of hydrocarbons and fluids may be evaluated using known techniques. The interfacial tension value for a mixture of hydrocarbons and water may be determined using a spinning drop tensiometer. An amount of the surfactant(s) containing injectable fluid may be added to the hydrocarbon/water mixture and the interfacial tension value for the resulting fluid may be determined.

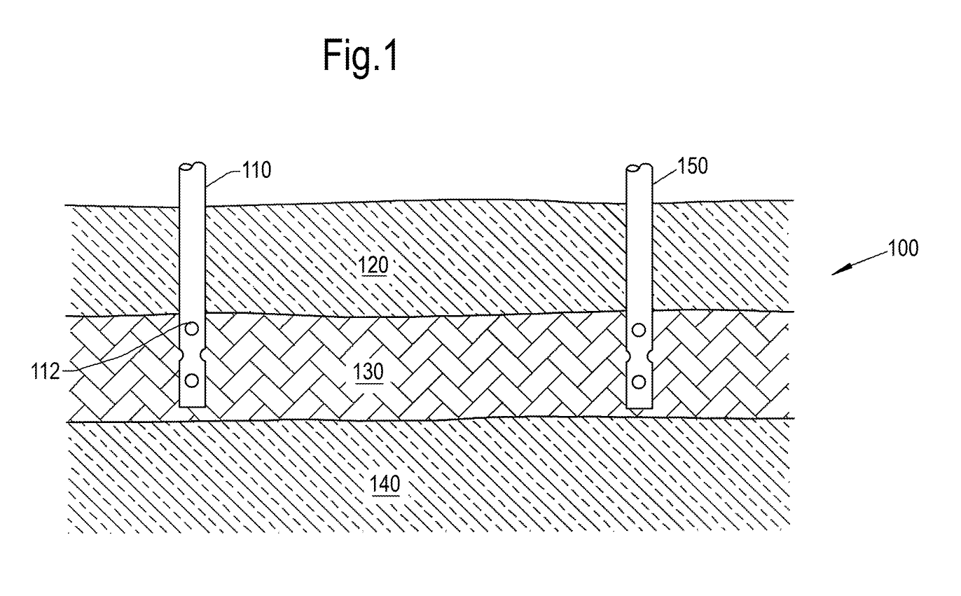

The surfactant(s) containing injectable fluid may be provided (for example injected) into hydrocarbon containing formation 100 through injection well 110 as depicted in FIG. 1. Hydrocarbon containing formation 100 may include overburden 120, hydrocarbon layer 130 (the actual hydrocarbon containing formation), and underburden 140. Injection well 110 may include openings 112 (in a steel casing) that allow fluids to flow through hydrocarbon containing formation 100 at various depth levels. Low salinity water may be present in hydrocarbon containing formation 100.

The surfactant(s) from the surfactant(s) containing injectable fluid may interact with at least a portion of the hydrocarbons in hydrocarbon layer 130. This interaction may reduce at least a portion of the interfacial tension between one or more fluids (for example water, hydrocarbons) in the formation and the underburden 140, one or more fluids in the formation and the overburden 120 or combinations thereof.

The surfactant(s) from the surfactant(s) containing injectable fluid may interact with at least a portion of hydrocarbons and at least a portion of one or more other fluids in the formation to reduce at least a portion of the interfacial tension between the hydrocarbons and one or more fluids. Reduction of the interfacial tension may allow at least a portion of the hydrocarbons to form an emulsion with at least a portion of one or more fluids in the formation. The interfacial tension value between the hydrocarbons and one or more other fluids may be improved by the surfactant(s) containing injectable fluid to a value of less than 0.1 mN/m or less than 0.05 mN/m or less than 0.001 mN/m.

At least a portion of the surfactant(s) containing injectable fluid/hydrocarbon/fluids mixture may be mobilised to production well 150. Products obtained from the production well 150 may include components of the surfactant(s) containing injectable fluid, methane, carbon dioxide, hydrogen sulfide, water, hydrocarbons, ammonia, asphaltenes or combinations thereof. Hydrocarbon production from hydrocarbon containing formation 100 may be increased by greater than 50% after the surfactant(s) containing injectable fluid has been added to a hydrocarbon containing formation.

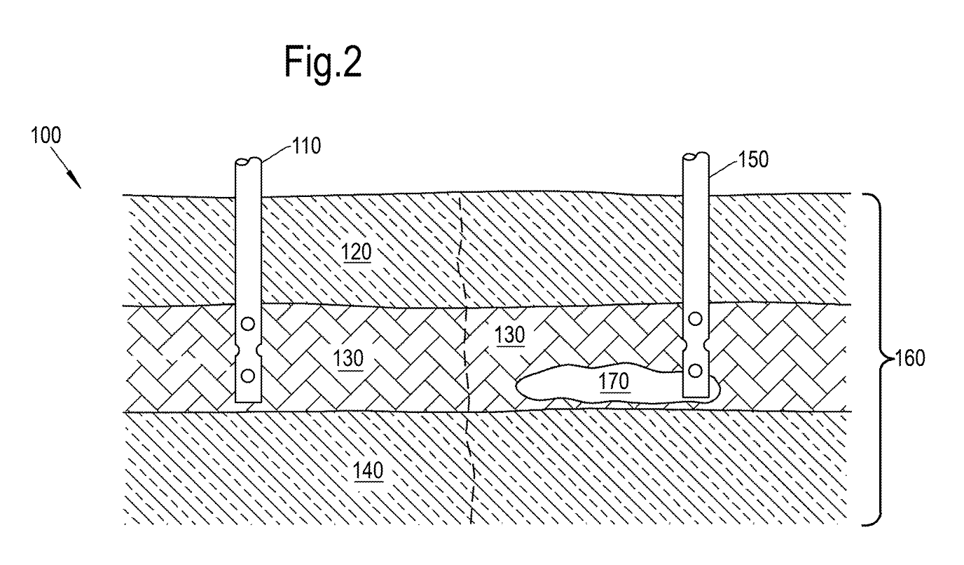

The surfactant(s) containing injectable fluid may also be injected into hydrocarbon containing formation 100 through injection well 110 as depicted in FIG. 2. Interaction of the surfactant(s) from the surfactant(s) containing injectable fluid with hydrocarbons in the formation may reduce at least a portion of the interfacial tension between the hydrocarbons and underburden 140. Reduction of at least a portion of the interfacial tension may mobilise at least a portion of hydrocarbons to a selected section 160 in hydrocarbon containing formation 100 to form hydrocarbon pool 170. At least a portion of the hydrocarbons may be produced from hydrocarbon pool 170 in the selected section of hydrocarbon containing formation 100.

1. A method of treating a hydrocarbon containing formation, comprising:
a) providing an aqueous composition which comprises i) a surfactant of the formula R—O—[R′—O]ₓ—X wherein R is a hydrocarbyl group, R′—O is an alkylene oxide group, x is the number of alkylene oxide groups R′—O, x is 0 or greater than 0, and X is a sulfate moiety; ii) an acid which has a pKₐ between 6 and 12; and iii) the conjugate base of the acid mentioned under ii), to at least a portion of the hydrocarbon containing formation, by combining the aqueous composition with a hydrocarbon removal fluid to produce an injectable fluid, wherein the hydrocarbon removal fluid comprises 1) water and 2) divalent cations in a concentration of 100 or more parts per million by weight (ppmw), and injecting the injectable fluid into the hydrocarbon containing formation; and
b) allowing the surfactant from the injectable fluid to interact with the hydrocarbons in the hydrocarbon containing formation.

2. The method of claim 1, wherein the method is preceded by transporting the aqueous composition to the location of the hydrocarbon containing formation.
